(19) United States
(12) Patent Application Publication
(10) Pub. No.: US 2026/0119803 A1
(43) Pub. Date: Apr. 30, 2026

(54) KNOWLEDGE REFINEMENT FOR LANGUAGE MODEL ENHANCEMENT

(71) Applicant: Intuit Inc., Mountain View, CA (US)

(72) Inventors: Jiaxin ZHANG, Mountain View, CA (US); Wendi CUI, Jersey City, NJ (US); Yiran HUANG, San Diego, CA (US); Kamalika DAS, Saratoga, CA (US); Sricharan KALLUR PALLI KUMAR, Milpitas, CA (US)

(21) Appl. No.: 18/927,583

(22) Filed: Oct. 25, 2024

(51) Int. Cl. G06F 40/35

(52) U.S. Cl. CPC G06F 40/35

(57) ABSTRACT

Certain embodiments of the disclosure provide techniques for knowledge refinement for language model fine-tuning. A method generally includes obtaining a raw information item; partitioning the raw information item into a plurality of first contextual units, wherein each first contextual unit comprises a first portion of the raw information item; generating, via a first language model, first synthetic data based on: the plurality of first contextual units; the raw information item; and at least one of fine-grained synthesis, interleaved generation, or assembly augmentation; and fine-tuning a second language model based on the first synthetic data.

### BACKGROUND

### Field

Aspects of the present disclosure relate to knowledge refinement for language model fine-tuning.

### Description of Related Art

A key long-term goal of artificial intelligence (AI) is to create machines capable of understanding and engaging in conversation with humans using natural language. Dialogue systems, which can communicate with users in natural language, may carry out unstructured conversations, with users, on any topic (e.g., open-domain systems). Performant dialogue systems exhibit competence in understanding natural language, making informed decisions, and generating fluent, engaging, contextually appropriate, and accurate responses.

An example dialogue system may leverage language models, such as large language model(s) (LLM(s)), to perform natural language processing (NLP) tasks. A language model is a type of machine learning (ML) model that supports NLP tasks, such as generating text, analyzing sentiments, answering prompts (e.g., specific instructions and/or requests posed in natural language) in a conversational manner, translating text from one language to another, and/or the like. Language models make it possible for software to “understand” typical human speech or written content and respond to it by, in some cases, generating human-understandable responses through natural language generation (NLG). An LLM is a type of language model that has a large number of parameters, such a language model with greater than 100 billion parameters (although, it is noted, that the number of parameters generally associated with a simple language model and an LLM may change over time).

A popular LLM, which has gained much recent attention, is “ChatGPT,” produced by OpenAI® of San Francisco, California. Generative pre-trained transformer (GPT) models, such as ChatGPT, are a specific type of LLM based on a transformer architecture (e.g., architecture that uses an encoder-decoder structure and does not rely on recurrence and/or convolutions to generate an output), pre-trained in a generative and unsupervised manner (e.g., it learns from data without being given explicit instructions on what to learn). GPT models analyze prompts and predict the best possible responses based on their understanding of the language.

While language models, and more specifically LLMs such as ChatGPT, represent a transformative force in many industries by assimilating vast amounts of knowledge, such as to build conversation-driven applications, these models are not without limitation. For example, while a powerful tool, an LLM may only be as good as the underlying training data used to train the model.

### SUMMARY

Certain embodiments provide a method of language model fine-tuning, comprising: obtaining a raw information item; partitioning the raw information item into a plurality of first contextual units, wherein each first contextual unit comprises a first portion of the raw information item; generating, via a first language model, first synthetic data based on: the plurality of first contextual units; the raw information item; and at least one of fine-grained synthesis, interleaved generation, or assembly augmentation; and fine-tuning a second language model based on the first synthetic data.

Other embodiments provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain embodiments and are therefore not to be considered limiting of the scope of this disclosure.

FIG. 1 depicts an example system implementing a large language model.

FIG. 2A depicts an example workflow for knowledge refinement and language model fine-tuning.

FIG. 2B depicts example techniques used for knowledge refinement.

FIG. 2C depicts example prompts used to generate synthetic data.

FIGS. 3A-3B depict example fine-tuning performance evaluation for different example knowledge refinement techniques.

FIGS. 4A-4B depict another example fine-tuning performance evaluation for different example knowledge refinement techniques.

FIG. 5 depicts example supervised fine-tuning performance using different synthetic data generated for three different datasets.

FIG. 6 depicts an example method for language model fine-tuning.

FIG. 7 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Pre-training is the initial phase of training for LLMs. Pre-training starts with an untrained model (e.g., a model that has randomly initialized weights), and trains it to predict a next token given a sequence of previous tokens. In the context of LLMs, tokens may be units of text that the models process and generate. Tokens can represent individual characters, words, subwords, or even larger linguistic units, depending on the specific tokenization (e.g., segmentation of text into meaningful units to capture its semantic and syntactic structure) approach used. Tokens act as a bridge between the raw text data and the numerical representations that LLMs are able to work with. Training data used to pre-train an LLM generally includes publicly available “raw text,” for example, from books, articles, websites, and/or the like. To be highly capable (e.g., have linguistic and world knowledge), this text may span a wide range of fields, genres, languages, etc. Eventually, training on large amounts of text, the model learns to encode the structure of language in general (e.g., it learns, that “I like,” for example may be followed by a noun or a participle) as well as the knowledge included in the raw texts that the model was exposed to during training. For example, an LLM may learn, that the sentence “George Washington was . . . ” is often followed by “the first president of the United States,” and hence has a representation of that piece of knowledge.

Although a pre-trained LLM is, due to the knowledge it encodes, able to perform a variety of tasks, the model may lack specific knowledge that is not encoded in its training data. This knowledge may include (1) dynamic knowledge, (2) domain-specific knowledge, and/or (3) previously-acquired knowledge that has since been lost, to name a few. For example, dynamic knowledge refers to information that is constantly evolving, such as a user's age, an outstanding loan balance, stock prices, sensor data (e.g., such as from a thermostat inside a home), website analytics, and the like. Dynamic knowledge may become static and fail to evolve over time; thus, such knowledge encoded by the LLM may become outdated.

Domain-specific knowledge (also referred to as “domain knowledge”) in ML refers to expertise and understanding of a specific field or subject matter (referred to herein as a “domain”) to which an ML model is applied. LLMs may suffer from a domain knowledge deficit where they lack detailed, specialized knowledge for a particular domain, such as finance, healthcare, law, etc. For example, a general-purpose LLM (e.g., off-the-shelf LLM) pre-trained on publicly-available data may not be able to respond, or may respond incorrectly, to a domain-specific prompt, such as a prompt requesting information about a company's financial statements and/or accounts, a prompt requesting software code for an application, a prompt requesting information about employee retention at a particular company for a previous year, a prompt requesting customer help with an application and/or system internal to a company, and/or the like. The pre-trained LLM may not be able to respond, or may respond incorrectly, given the information that is requested is not part of a publicly available training data used to pre-train the LLM.

Additionally, there is the technical problem of catastrophic forgetting, where LLMs may lose or forget previously-acquired knowledge as the model is trained on new data. This phenomenon may occur due to the limitations of the training process, as model training may prioritize recent data and/or tasks at the expense of earlier data. As a result, the LLM's representations of certain concepts and/or knowledge may degrade and/or may become replaced by newer information, leading to a loss of overall performance and/or accuracy on tasks that require a broad understanding of diverse topics. Rare facts that are minimally represented in the training data may be particularly prone to catastrophic forgetting.

To address the shortcomings of LLMs, some conventional approaches seek to combine and orchestrate LLM functionality with other sources of knowledge. For example, some conventional approaches use techniques to “fine-tune” LLMs for specific domains, while also regularly performing updates to their knowledge bases. Fine-tuning LLMs for specific domains may involve adapting a pre-trained language model to generate domain-specific text and/or initiate or perform domain-specific tasks. This process allows the language model to better understand and generate content that aligns with a particular field or subject matter of interest.

One technique for customizing LLMs to specialized domains includes supervised fine-tuning (SFT). SFT involves adapting a pre-trained LLM to a specific downstream task using labeled data. For example, during SFT, a pre-trained LLM may be fine-tuned on the labeled dataset using supervised learning techniques. The pre-trained LLM's weights may be adjusted based on gradients derived from the task-specific loss, which measures the difference between the LLM's predictions and the ground truth labels (e.g., the true and correct labels or outputs associated with the dataset). The additional dataset and training, associated with SFT, may allow the LLM to learn task-specific patterns, improving its domain understanding. The fine-tuned LLM may better understand the provided data, as well as perform better on related queries. For example, the LLM may not only produce more factually accurate responses, but may also construct them appropriately for a task. As an illustrative example, an LLM acting as a chatbot for a customer support service that has been trained using a series of validated training examples, may provide a better, more emphatic answer to a customer support question of “I can't log into my account. What should I do?,” such as “I'm sorry to hear you're having trouble logging in. You may try resetting your password using the ‘Forgot Password’ option on the login page” instead of simply “Reset your password.”

Techniques in fine-tuning may also include continual pre-training (CPT) (also referred to as “continued pre-training” or “continuous pre-training”), or unsupervised fine-tuning. CPT refers to the practice of taking a general-purpose LLM (e.g., off-the-shelf LLM) and progressing the training of the model using new large quantities of unstructured data. The training process is similar to the one used for the original pre-training of the model, and the new dataset may be referred to as the training set. CPT is often used for domain adaptation where the training set contains domain-specific data, such as manuals, documents, emails, new language, frequently-asked-questions (FAQs), and/or the like. CPT updates the LLM's parameters, and the LLM learns the domain knowledge, style, terminology, and/or governing principles. CPT of LLMs beneficially allows for the integration of domain-related knowledge, enhancing the textual representation of concepts and improving learning efficiency.

It should be noted that the above-described fine-tuning techniques are only example strategies that may be used to adapt a pre-trained model for specific tasks or domains. In other words, the above-described fine-tuning techniques are not an exhaustive list, and many other techniques may be considered and utilized.

Though the aforementioned, fine-tuning techniques for integrating precise and current knowledge may be useful for broadening the utility and effectiveness of LLMs for particular domains and/or for performing specific tasks, the performance of LLMs often remains suboptimal, with issues such as hallucinations, especially in tasks that require extensive knowledge. One important technical difficulty for fine-tuning is the preparation of performant fine-tuning data. Specifically, the quality and format of the data used for fine-tuning an LLM may play an instrumental role in determining the effectiveness of the resulting model.

Depending on the model, specific task, and/or fine-tuning technique utilized, certain data formats may be more effective than others for fine-tuning. For example, in a text classification task, using a format that separates an input text and its corresponding label with a special token may lead to better results compared to other formats (e.g., such as a raw text corpus, also referred to herein as a “raw information item”). Thus, strategies for formatting knowledge prior to LLM fine-tuning, such that the knowledge is readily assimilable by the LLM, may be desired.

Embodiments described herein overcome the aforementioned technical problems and improve upon the state of the art by introducing a synthetic data generation method (also referred to herein as “synthetic knowledge ingestion (SKI)”) that automates and enhances knowledge ingestion, prior to knowledge injection by an LLM. As used herein, “knowledge ingestion” may refer to techniques for acquiring, integrating, and/or transforming information from one or more knowledge sources. Knowledge ingestion may including gathering, absorbing, and/or converting raw knowledge (also referred to herein as a “raw information item”) into refined knowledge to build a database that facilitates future use, such as for knowledge injection via LLM fine-tuning. “Knowledge injection” may include actively encoding and/or integrating specific knowledge (e.g., refined knowledge created via “knowledge ingestion”) into a pre-trained LLM to enhance its performance by incorporating new information from external datasets and/or by refining the model's capabilities on previously-seen information.

The synthetic data generation method described herein may (1) process raw information item(s) into contextual units and (2) leverage one or more techniques to generate high-quality and diverse data representation(s) for the raw information item, such as based on the contextual unit(s). As used herein, an “information item” is a broad term used to encompass a piece of content and/or data that contains information relevant to a particular domain, topic, and/or subject. Example information items may include documents, articles, webpages, and/or other forms of structured and/or unstructured data. Additionally, as used herein, “raw,” used to further define an “information item,” may indicate that the information item is unprocessed, or more specifically that the information item has not been organized and/or manipulated in any way. The information item may simply be collected from one or more knowledge sources, such as devices, sensors, and/or databases, among others. In certain aspects, a raw information item may include domain-specific knowledge used to fine-tune an LLM. A “contextual unit” is a smaller portion of an information item, such as a sentence, a paragraph, and/or a group of related sentences and/or paragraphs that conveys a particular idea or concept within the larger information item. An example contextual unit may include the sentence “George Washington was born on Feb. 22, 1732 in Westmoreland, County, Virginia” in a larger corpus of text including three sentences, namely “George Washington was born on Feb. 22, 1732 in Westmoreland, County, Virginia. He died on Dec. 14, 1799. George Washington was an American general and commander in chief of the colonial armies in the American Revolution and subsequently the first president of the United States.”

A first technique for knowledge ingestion, described herein, includes “fine-grained synthesis” used to create synthetic data for a raw information item. For example, fine-grained synthesis may be used to create (1) questions (e.g., hypothetical questions) (Q) and/or (2) question-context (QC) tuples based on one or more contextual units associated with the raw information item. As used herein, a tuple refers to a set of elements, such as, for example, an ordered sequence of elements. Each question-context pair may include a generated question and a contextual unit used to generate the question. Fine-grained synthesis, such as when used with interleaved generation, may beneficially help to minimize the semantic gap between questions and answers, while also increasing the representation diversity (e.g., the inclusion of a wide range of different examples and attributes) of training data used to fine-tune an LLM.

A second technique for knowledge ingestion, described herein, includes “interleaved generation” used to create synthetic data for a raw information item. For example, interleaved generation may be used to simultaneously generate both questions and answers based on one or more contextual units associated with the raw information item. The questions and answers generated may be used to create (1) question-answer (QA) tuples and/or (2) question-context-answer (QCA) tuples. Each question-context-answer tuple may include a generated question, a generated answer corresponding to the generated question, and a contextual unit used to generate the question and the answer. The question-answering format of synthetic data generated via interleaved generation may naturally mirror the process of information-seeking, providing direct contextual alignment and relevance between the questions and their respective answers.

A third technique for knowledge ingestion, described herein, includes “assembly augmentation” used to create synthetic data for a raw information item. For example, assembly augmentation may be used to generate (1) a combined question-answer set, or assembly (QA-ASM), including multiple question-answer tuples created for an information item (e.g., via interleaved generation), (2) a combined question-context set, or assembly (QC-ASM), including multiple question-context tuples created for an information item (e.g., via fine-grained synthesis), and/or (3) a combined question-context-answer set, or assembly (QCA-ASM), including multiple question-context-answer tuples created for an information item (e.g., via interleaved generation).

By leveraging one or more of the aforementioned techniques, the synthetic data generation method described herein thus provides significant technical advantages over conventional solutions. For example, such technique(s), when utilized, may offer a solution for generating synthetic data from raw knowledge, which is diverse, representative, and relevant, among other qualities. For example, the synthetic data generation technique(s) may beneficially help to generate synthetic data that is not too broad, which struggles to encompass all pertinent knowledge points of a raw information item, yet also not excessively detailed, which risks risk losing sight of the overall content provided by the raw information item. Moreover, the synthetic data generation technique(s) help to generate synthetic data that is both non-repetitive and diverse.

As such, the synthetic data generation method described herein beneficially enhances the refinement of knowledge from its raw state, thereby facilitating effective knowledge injection into LLMs. For example, the generated synthetic data may be injected into an LLM, using one or more techniques, such as via fine-tuning. Accordingly, new information from external datasets may be incorporated into a pre-trained LLM and/or the LLM's capabilities on previously-seen information may be refined, thereby enhancing the performance of the LLM.

Notably, the synthetic data generation techniques described herein can further improve the function of any existing application used to fine-tune an ML model. For example, such techniques may be used to easily transform raw knowledge into refined data representations that an ML model may effectively digest. Digestion of such information may adjust the ML model's parameters for a specific task and/or domain, thereby improving the overall performance of the ML model with respect to the specific task and/or domain.

### Example System Implementing a Language Model

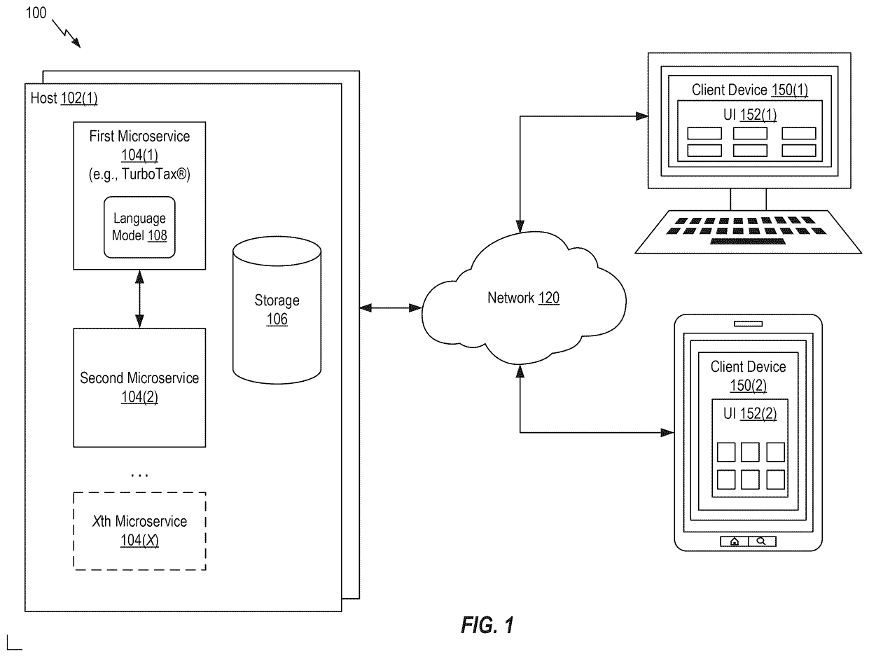

FIG. 1 depicts an example system 100 supporting a microservice 104(1) (e.g., software-defined service, which in some cases, may be cloud-native) implementing one or more language models 108, such as LLM(s).

As shown in FIG. 1, system 100 comprises client devices 150(1)-(2) (collectively referred to herein as “client devices 150”) and host(s) 102 interconnected through a network 120. Network 120 may be, for example, a direct link, a local area network (LAN), a wide area network (WAN), such as the Internet, another type of network, or a combination of one or more of these networks.

Host(s) 102 may be geographically co-located servers on the same rack or on different racks in any arbitrary location in a data center. Host(s) 102 may be constructed on a server grade hardware platform and include components of a computing device such as, one or more processors (central processing units (CPUs)), one or more memories (random access memory (RAM)), one or more network interfaces (e.g., physical network interfaces (PNICs)), storage 106, and other components (e.g., only storage 106 is shown in FIG. 1).

A first host 102(1) in system 100 may host a plurality of microservices 104(1)-(X) (collectively referred to herein as “microservices 104”), where X is an integer greater than one. The microservices 104 may be deployed using virtual machines (VMs) and/or container(s) running on first host 102(1) (e.g., where first host 102(1) is running a hypervisor (not shown) used to abstract processor, memory, storage, and networking resources of first host 102(1)'s hardware platform). Generally, microservices 104 are loosely coupled and independently deployable services (or software) that may make up an application. Microservices 104 may enable segmented, granular level functionalities within a larger system infrastructure.

Client device 150(1) and client device 150(2) may each include a user interface (UI) 152(1), 152(2), respectively, which may be used to communicate with, at least, a first microservice 104(1), a second microservice 104(2), and/or through an X-th microservice 104(X) using the network 120. For example, communication between client devices 150 and a microservice 104 may be facilitated by one or more application programming interfaces (APIs). Examples of client devices 150 may include a smartphone, a personal computer, a tablet, a laptop computer, and/or other devices.

As shown in FIG. 1, in certain embodiments, the first microservice 104(1) implements an information service, which is any network 120 accessible service that maintains financial data, medical data, personal identification data, and/or other data types. For example, the information service may include TurboTax® and its variants made commercially available by Intuit® of Mountain View, California. In certain embodiments, the first microservice 104(1) implements one or more language models 108, such as LLM(s). First microservice 104(1) may implement language model(s) 108 to provide responses to user prompts, including responses such as answers, advice, and/or help with the preparation of documents and/or reports. For example, TurboTax®, an example information service, may utilize a language model 108 to aid users of the application with preparing one or more financial documents. Language model 108 may provide answers to questions asked by a user of the application, prepare and output one or more reports and/or documents for the user, etc.

In certain embodiments, the language model(s) 108 may be fine-tuned for one or more specific domains. Fine-tuning language model(s) for specific domains may involve adapting a pre-trained language model to generate domain-specific text and/or initiate or perform domain-specific tasks. For example, a language model 108 implemented via TurboTax® (an example information service) may be fine-tuned to generate tax returns that comply with current tax laws and take into consideration specific user information to accurately report an amount owed/overpaid to the government by a user. The language model 108 may be fine-tuned to perform this specific task using information from the United States Tax Code, among others.

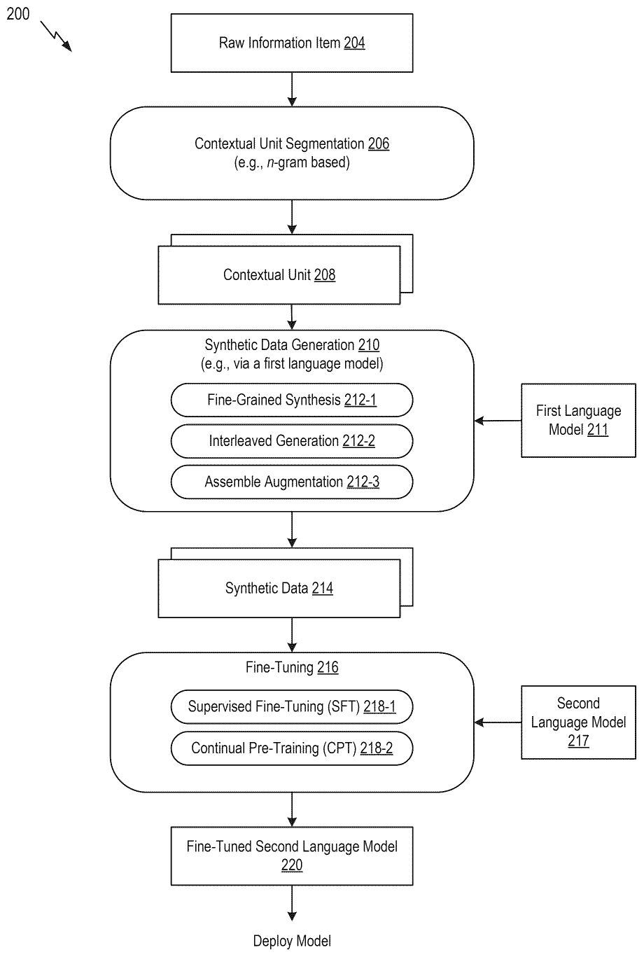

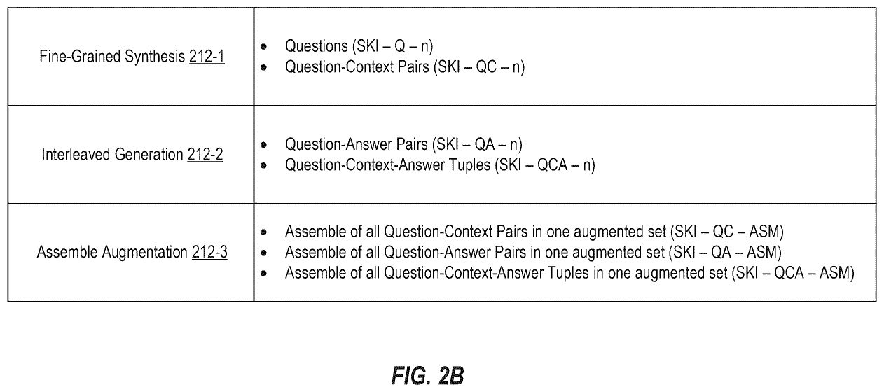

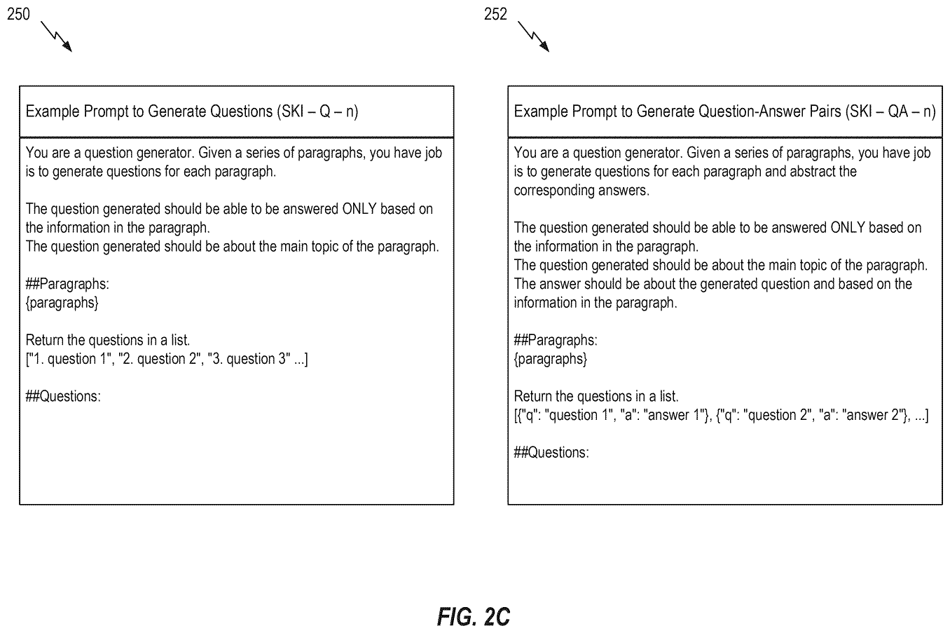

In certain embodiments, the language model(s) may be fine-tuned using the techniques described herein. For example, a synthetic data generation method may be used to enhance the refinement of knowledge from its raw state, thereby facilitating effective knowledge injection into LLMs. Knowledge refinement may include generating synthetic data for a raw information item used to fine-tune the language model(s), such as based on fine-grained synthesis, interleaved generation, and/or assembly augmentation. Each of these techniques are described in detail below with respect to FIGS. 2A and 2B.

Though FIG. 1 depicts each of first host 102(1), storage 106, client device 150(1), and client device 150(2) as single devices for ease of illustration, first host 102(1), storage 106, client device 150(1), and/or client device 150(2) may be embodied in different forms for different implementations. Further, though FIG. 1 depicts only two hosts 102 and two client devices 150, other embodiments may include more or less hosts 102 and/or client devices 150, and client devices 150 may use any combination of microservices 104 on any host 102 where microservices 104 are deployed.

### Example Workflow for Knowledge Refinement and Language Model Fine-Tuning

FIG. 2A depicts an example workflow 200 for knowledge refinement and language model fine-tuning. For example, workflow 200 may be used to generate synthetic data from raw information items, which may then be used to enhance the capabilities of language models in various domains, such as finance, healthcare, and/or open-generation tasks, to name a few. In certain embodiments, workflow 200 includes performing fine-grained synthesis 212-1, interleaved generation 212-2, and/or assembly augmentation 212-3 (e.g., synthetic data generation strategies) to construct data representations from raw information items. Such strategies may be applied to various knowledge injection techniques, such as CPT and/or SFT, to refine and enhance the knowledge capabilities of language models.

In certain embodiments, workflow 200 is used to enhance the knowledge capabilities of a second language model 217 shown in FIG. 2A. In certain embodiments, second language model 217 may be an example of language model 108 of FIG. 1. In certain embodiments, second language model 217 may be an LLM. Example second language models 217 may include Mistral-7B, Llama2-7B, Contriever, BM25, etc. Although workflow 200 is described with respect to fine-tuning an LLM, it is noted that, in certain other embodiments, workflow 200 may be similarly used to enhance the knowledge capabilities of other language models.

Workflow 200 begins with obtaining a raw information item 204. As described above, an “information item” refers to a piece of content and/or data that contains information relevant to a particular domain, topic, and/or subject. Further, the term “raw,” used to further define an “information item,” may indicate that the information item is unprocessed, or more specifically that the information item has not been organized and/or manipulated in any way. Example raw information item 204 may include a textual document, such as an article, a research paper, or a report; structured data, such as a database or a spreadsheet; a web page or web content; a social media post and/or social media comments; a product description and/or a technical specification; a legal document; educational material and/or course content; a news article; a press release; a customer review and/or feedback; image data; audio data; video data; and/or other structured and/or unstructured data.

A raw information item 204 may be obtained from one or more knowledge sources, such as device(s), sensor(s), database(s), storage system(s), etc. In certain embodiments, a raw information item 204 is obtained from an information repository (not shown in FIG. 2A) implemented using one or more storage devices, such as hard disk drives, solid-state drives, and/or cloud-based storage systems. The information repository may be regularly updated to add new raw information items 204 to the repository and/or update existing raw information items stored in the repository (e.g., such as dynamic knowledge, captured in the raw information items 204, evolves over time).

Although workflow 200 is described with respect to processing a single raw information item 204 (e.g., such as a single document, a single article, etc.), in certain other embodiments, workflow 200 may be used to process multiple raw information items 204, such as sequentially or in parallel, depending on the configuration and/or available resources.

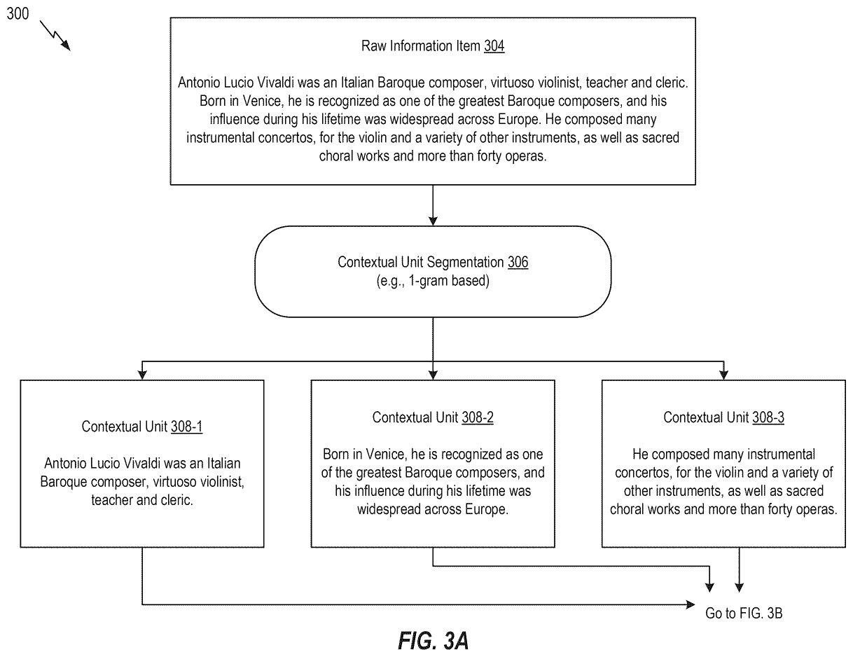

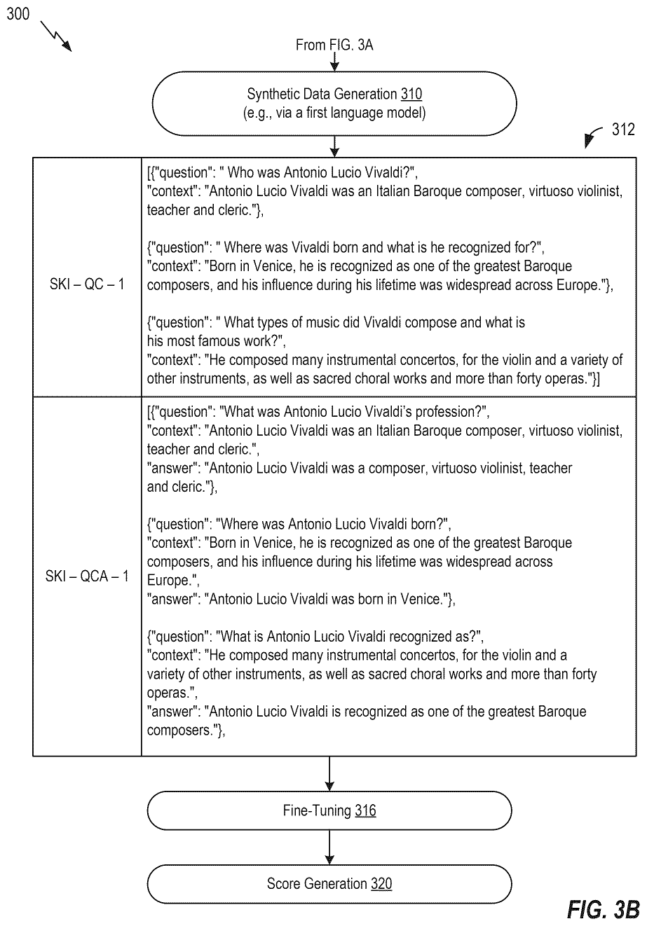

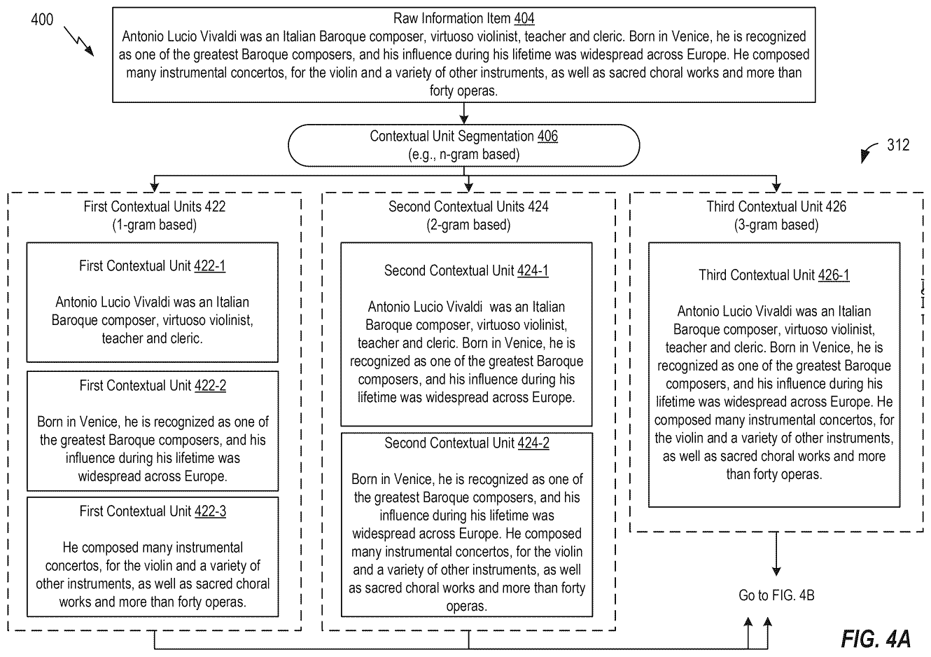

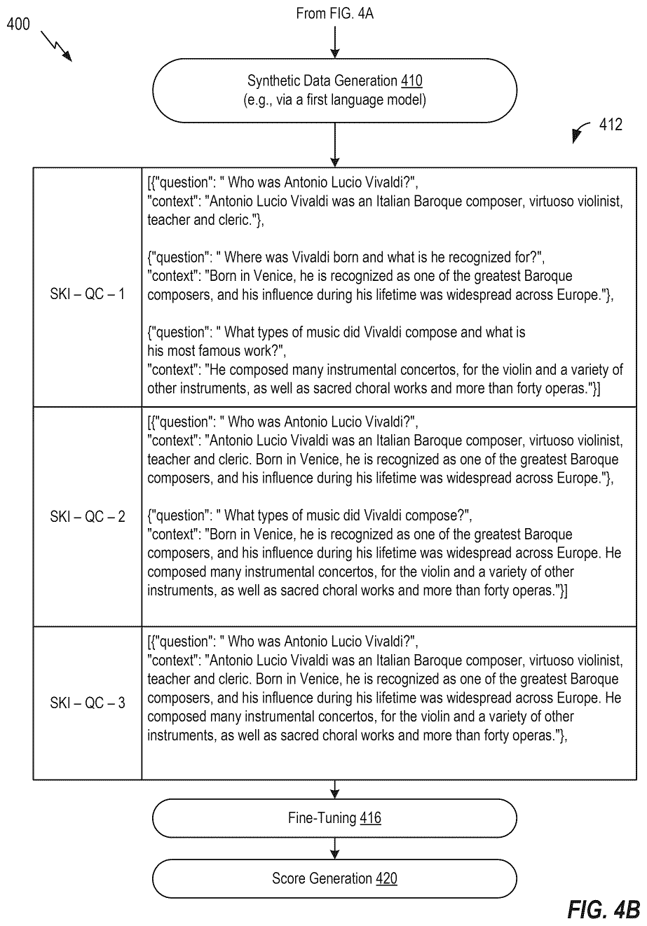

Workflow 200 then proceeds with contextual unit segmentation 206. Contextual unit segmentation 206 may involve partitioning the raw information item 204 into one or more contextual units 208. In other words, contextual unit segmentation 206 my include dividing a raw information item 204 into, or otherwise extract, smaller units of information, referred to herein as contextual units 208. As described above, a “contextual unit 208” is a smaller portion of the raw information item 204. An example contextual unit 208 may include a sentence, a paragraph, multiple sentences, multiple paragraphs, etc. that conveys a particular idea or concept within the larger raw information item 204. Example contextual units 208 created for a raw information item 204 are depicted and described with respect to FIGS. 3A and 4A. The number and/or diversity of example contextual units 208 generated via contextual unit segmentation 206 may vary depending on the complexity and content of the raw information item 204, as well as the technique(s) used to perform the segmentation, as described in detail below.

Various techniques may be used to analyze the structure and/or content of a raw information item 204 to determine appropriate boundaries for partitioning the raw information item 204 into contextual units 208. For example, in certain embodiments, an n-gram approach may be used, for contextual unit segmentation 206, to divide a raw information item 204 into contextual units 208. The n-gram approach may involve creating sequences of n consecutive words and/or sentences from the raw information item 204. The value of n may be adjusted based on a desired granularity of the contextual units 208. For example, a 1-gram approach (e.g., n=1) may create contextual units 208, each consisting of a single individual sentence from raw information item 204. A 2-gram approach (e.g., n=2), on the other hand, may create contextual units 208, each consisting of two consecutive sentences from raw information item 204. Contextual unit segmentation 206 may utilize a 1-gram approach, a 2-gram approach, and/or another n-gram approach to partition raw information item 204 into contextual units 208.

In certain embodiments, contextual unit segmentation 206 may include performing one or more other segmentation techniques to divide raw information item 204 into, or otherwise extract, smaller units of information. These techniques may include, but may not be limited to, paragraph-based segmentation, topic-based segmentation, such as using natural language processing techniques, semantic similarity-based clustering, named entity recognition for entity-centric segmentation, and/or temporal or chronological segmentation for time-based content.

In certain embodiments, contextual unit segmentation 206 may include performing multiple segmentation techniques to create a diverse set of contextual units 208. As an illustrative example, a 1-gram and a 2-gram approach may be used to partition a same raw information item 204 into 1-sentence and 2-sentence contextual units 208. Creating multiple contextual units 208, such as using multiple segmentation techniques, may help to capture different aspects of the raw information item 204 and/or provide a richer, more diverse set of contextual units 208 for further processing. For example, when processing a long-form article about climate change, paragraph-based segmentation may be used to first create initial contextual units 208. Named entity recognition techniques may then be applied to identify key concepts like “greenhouse gases” and/or “sea level rise” among the contextual units 208. Finally, a semantic similarity clustering technique may be used to group related contextual units 208 together. Accordingly, the resulting contextual units 208 may capture both the structure and the semantic content of the raw information item 204.

In certain embodiments, contextual units 208, generated via contextual unit segmentation 206, may serve as the basis for generating synthetic data 214, such as for knowledge injection by second language model 217. For example, as shown in FIG. 2A, after generating contextual units 208, workflow 200 proceeds with synthetic data generation 210.

Synthetic data generation 210 involves the creation of artificial data associated with raw information item 204. For example, synthetic data generation 210 may include generating synthetic data 214 based on contextual units 208 associated with raw information item 204. As shown in FIG. 2A, synthetic data generation 210 may include performing fine-grained synthesis 212-1, interleaved generation 212-2, and/or assembly augmentation 212-3. The outputs of each technique are outlined in FIG. 2B.

For example, fine-grained synthesis 212-1 may include generating hypothetical questions based on the contextual units 208 associated with raw information item 204, conditioning on the entire raw information 204. For example, a first contextual unit 208 may be used to generate a first hypothetical question, a second contextual unit 208 may be used to generate a second hypothetical question, a third contextual unit 208 may be used to generate a third hypothetical question, and so forth. The hypothetical questions generated may then be used to create synthetic data 214, including (1) questions (SKI−Q−n) and/or (2) question-context tuples (SKI−QC−n). For example, where a 2-gram approach is used to create contextual units 208 during contextual unit segmentation 206, then synthetic data generation 210 may include performing fine-grained synthesis 212-1 to generate (1) questions based on 2-sentence contextual units 208 (SKI−Q−2) and/or (2) question-context tuples based on 2-sentence contextual units 208 (SKI−QC−2). A question-context pair may include, not only the hypothetical question generated based on a contextual unit 208, but also the contextual unit 208 itself (or some variation of the contextual unit 208, such as a shortened or expanded version of the contextual unit 208). In certain embodiments, fine-grained synthesis 212-1 may be used to create a balanced dataset of both detailed and hierarchical synthetic content, such as to address a technical challenge of crafting effective questions that capture knowledge of the raw information item 204, without overlooking the overall context of the raw information item 204.

Interleaved generation 212-2 may include generating hypothetical question and answer tuples based on the contextual units 208 associated with raw information item 204, conditioning on the entire raw information 204. For example, a first contextual unit 208 may be used to simultaneously generate a first hypothetical question and a corresponding first answer, a second contextual unit 208 may be used to simultaneously generate a second hypothetical question and a corresponding second answer, a third contextual unit 208 may be used to simultaneously generate a third hypothetical question and a corresponding third answer, and so forth. The hypothetical questions and answers generated may then be used to create synthetic data 214, including (1) question-answer tuples (SKI−QA−n) and/or (2) question-context-answer tuples (SKI−QCA−n). For example, where a 2-gram approach is used to create contextual units 208 during contextual unit segmentation 206, then synthetic data generation 210 may include performing interleaved generation 212-2 to generate (1) question-answer tuples based on 2-sentence contextual units 208 (SKI−QA−2) and/or (2) question-context-answer tuples based on 2-sentence contextual units 208 (SKI−QCA−2). A question-answer pair may include a generated hypothetical question and its corresponding answer. A question-context-pair may include, not only the hypothetical question and answer generated based on a contextual unit 208, but also the contextual unit 208 itself (or some variation of the contextual unit 208, such as a shortened or expanded version of the contextual unit 208). As such, interleaved generation 212-2 may be used to simultaneously generate questions and corresponding answers based on specific knowledge contexts contained within raw information item 204, thereby providing contextual alignment and relevance between questions and their corresponding answers.

Assembly augmentation 212-3 may include combining n-gram syntheses and/or various synthetic data tuple types (question-context, question-answer, and question-context-answer) to create a multifaceted knowledge representation of the raw information item 204, such as for knowledge injection by second language model 213. For example, in certain embodiments, assembly augmentation 212-3 may include creating an assembly (where “assembly” is also referred to herein as “ASM”) of two or more question-answer tuples (e.g., such as all question-answer tuples generated for raw information item 204) into one augmented set (referred to herein as a “combined question-answer set”) (SKI−QA−ASM). The question-answer tuples may include question-answer tuples generated based on contextual units 208 created using a same n-gram approach or different n-gram approaches. For example, the combined question-answer set may include question-answer tuples generated based on contextual units 208 created using both a 1-gram and a 2-gram approach (e.g., 1-sentence and 2-sentence contextual units 208) or only a 1-gram approach. In certain embodiments, assembly augmentation 212-3 may include creating an assembly of two or more question-context tuples (e.g., such as all question-context tuples generated for raw information item 204) into one augmented set (referred to herein as a “combined question-context set”) (SKI−QC−ASM). The question-context tuples may include question-context tuples generated based on contextual units 208 created using a same n-gram approach or different n-gram approaches. In certain embodiments, assembly augmentation 212-3 may include creating an assembly of two or more question-context-answer tuples (e.g., such as all question-context-answer tuples generated for raw information item 204) into one augmented set (referred to herein as a “combined question-context-answer set”) (SKI−QCA−ASM). The question-context-answer tuples may include question-context tuples generated based on contextual units 208 created using a same n-gram approach or different n-gram approaches. In certain embodiments, assembly augmentation 212-3 may be utilized to increase repetition and diversity, such as based on creating the multifaceted knowledge representation of the raw information item 204 (e.g., a diverse ensemble). Increasing the repetition and diversity helps to enhance the depth of breadth of knowledge that may be used to fine-tune second language model 213 (e.g., such as when compared to merely using raw information item 204). Further, the comprehensive assembly(ies) generated during assembly augmentation 212-3 may allow for the representation of complex relationships between different types of synthetic knowledge.

In certain embodiments, a first language model 211 may be used to perform synthetic data generation 210. For example, fine-grained synthesis 212-1, interleaved generation 212-2, and/or assembly augmentation 212-3 may performed based on prompting first language model 211 to generate synthetic data 214 (e.g., questions, question-context tuples, question-answer tuples, question-context-answer tuples, etc.). A prompt may comprise an input query or instruction, such as a natural language question, a keyword search, a more structured query, and/or the like. First language model 211 may generate synthetic data 214 based on contextual units 208. In certain embodiments, synthetic data 214, generated by first language model 211, may help to enrich content of the raw information item 204, which may be used to fine-tune second language model 217.

In certain embodiments, first language model 211 and second language model 217 are the same language model. In certain other embodiments, first language model 211 and second language model 217 are different language models. For example, first language model 211 may provide a distinct capability, different than second language model 217, such as generating synthetic data 214.

In certain embodiments, a prompt (not shown in FIG. 2A) may be provided as input to first language model 211 to trigger and guide first language model 211 in generating synthetic data 214 based on contextual units 208 (e.g., during synthetic data generation 210). In certain embodiments, a prompt may instruct first language model 211 to perform fine-grained synthesis 212-1, based on instructing first language model 211 to generate questions and/or question-context tuples based on contextual units 208. In certain embodiments, a prompt may instruct first language model 211 to perform interleaved generation 212-2, based on instructing first language model 211 to generate question-answer tuples and/or question-context-answer tuples based on contextual units 208. In certain embodiments, a prompt may instruct first language model 211 to perform assembly augmentation 212-3, based on instructing first language model 211 to generate a combined question-answer set, a combined question-context set, and/or a combined question-context-answer set based on contextual units 208.

In certain embodiments, a prompt used to trigger first language model 211 to perform synthetic data generation 210 may comprise a text string that includes instructions, context, and/or examples used to guide first language model 211 in generating relevant and accurate synthetic data for raw information item 204. In certain embodiments, the prompt may be dynamically generated based on the characteristics of the contextual units 208 and the desired output format for the synthetic data 214. A prompt may include elements such as a task description or instructions; relevant background information, formatting guidelines, examples of desired output, and/or constraints or parameters for the generated synthetic data 214.

FIG. 2C depicts example prompts 250, 252 used to generate synthetic data 214. Example prompt 250 is used to prompt first language model 211 to generate questions (e.g., perform fine-grained synthesis 212-1). Example prompt 252 is used to prompt first language model 211 to generate question-answer tuples (e.g., perform interleaved generation 212-2). Example prompt 250 asks first language model 211 to return, as output, a list of questions (e.g., Return the questions in a list. [“1. question 1”, “2. question 2”, “3. question 3” . . . ]) generated based on contextual units 208, which include different paragraphs from raw information item 204. Example prompt 252 asks first language model 211 to return, as output, a list of question-answer tuples (e.g., Return the questions in a list. [{“q”: “question 1”, “a”: “answer 1”}, {“q”: “question 2”, “a”: “answer 2”}, . . . ]) generated based on contextual units 208, which include different paragraphs from raw information item 204.

Returning to FIG. 2A, workflow 200 then proceeds with fine-tuning 216. Fine-tuning 216 is the process of retraining a pre-trained model to make it better suited for a specific task or dataset. For example, second language model 217 may be fine-tuned based on synthetic data 214, such as to improve performance of the second language model 217 for a particular domain (e.g., a domain associated with information included in raw information item 204 and thus synthetic data 214). This process may take place based on updating parameter(s) of the second language model 217 based on synthetic data 214.

In certain embodiments, fine-tuning 216 includes performing SFT 218-1. During SFT 218-1, second language model 211 may be fine-tuned using supervised learning techniques (e.g., using labeled data to train algorithms to recognize patterns and predict outcomes). For example, synthetic data 214 may include question-context-answer tuples, which may be injected (e.g., learned) by second language model 217 during SFT 218-1. For example, the question (Q) and context (C) of each question-context-answer tuple may be used as input when training the second language model 217. An output generated by the second language model may include a predicted answer to the question input into the model. This predicted answer may be compared to the answer associated with the question-context answer tuple, such as to determine whether to modify one or more parameters of second language model 217 during fine-tuning 216. In certain aspects, one or more metrics, or a loss function, may be used to measure the difference between the predicted answers and the answer associated with the question-context answer tuple. For example, cross entropy loss may be used for SFT 218-1, such as to measure the difference between a predicted probability distribution and an actual true distribution of the data.

In certain embodiments, fine-tuning 216 includes performing CPT 218-2. During CPT 218-2, second language model 217 may be fine-tuned using unsupervised learning techniques (e.g., a type of machine learning that learns patterns exclusively from unlabeled data). In certain embodiments, a larger volume of synthetic data 214 may be needed to perform CPT 218-2 to fine-tune second language model 217. To address this issue, in certain embodiments, synthetic data generation 210 may include performing assembly augmentation 212-3, such as to generate a combined question-answer set, a combined question-context set, and a combined question-context-answer set, which may be used for fine-tuning 216. This may help to amplify repetition, as well as preserve diversity.

Fine-tuning 216 results in obtaining a fine-tuned second language model 220 (e.g., a fine-tuned version of second language model 217). In certain embodiments, fine-tuned second language model 220 may be deployed for use. For example, when deployed, fine-tuned second language model 220 may be prompted to generate a response to a prompt. The prompt may be associated with a domain, for which the fine-tuned second language model 220 has been fine-tuned for. That is, the prompt may be associated with a domain that is also associated with raw information item 204 (e.g., used to fine-tune the fine-tuned second language model 220).

### Example Evaluation of Different Synthetic Data Formats for Langue Model Fine-Tuning

As described above, synthetic data used to fine-tune a language model may be generated to have different formats and/or may be generated based on contextual units created using different n-gram approaches. Different synthetic data generated may have different effects on the performance of a language model. For example, synthetic data in the form of question-answer tuples used to fine-tune a language model may result in better performance of the model with respect to a particular domain and/or task than when synthetic data in the form of question-context tuples are used to fine-tune the language model. As another example, synthetic data in the form of question-answer tuples, generated based on 1-gram contextual units, used to fine-tune a language model may result in better performance of the model with respect to a particular domain and/or task than when synthetic data in the form of question-answer tuples, generated based on 2-gram contextual units, are used to fine-tune the language model.

Thus, certain embodiments described herein provide techniques for experimenting with different synthetic data formats and/or types to identify a most suitable representation of synthetic data that may be used to fine-tune a language model. For example, certain embodiments provide techniques for generating different synthetic data, created using different synthetic data generation techniques (e.g., fine-grained synthesis, interleaved generation, and/or assembly augmentation), and evaluating each of their performances when used to fine-tune a language model. Certain other embodiments provide techniques for generating different synthetic data, created using different n-gram contextual units (e.g., 1-gram contextual units and 2-gram contextual units), and evaluating each of their performances when used to fine-tune a language model. Certain other embodiments provide techniques for generating different synthetic data, created using different synthetic data generation techniques and different n-gram contextual units, and evaluating each of their performances when used to fine-tune a language model.

FIGS. 3A and 3B depict example fine-tuning performance evaluation 300 for different example knowledge refinement techniques. More specifically, fine-tuning performance evaluation 300 depicted in FIGS. 3A and 3B may be used to evaluate the knowledge injection performance of a language model based on different types/formats of synthetic data 312 generated for a raw information item 304. For example, knowledge injection performance may be evaluated for question-context tuples (e.g., a first synthetic data type/format) and question-context-answer tuples (e.g., a second synthetic data type/format) generated for the same raw information item 304. The question-context tuples and the question-context-answer tuples may be generated based on the same contextual units 308, specifically 1-gram contextual units 308, associated with the raw information item 304.

As shown in FIG. 3A, example raw information item 304 is a paragraph, comprising three sentences, which recites:
Antonio Lucio Vivaldi was an Italian Baroque composer, virtuoso violinist, teacher and cleric. Born in Venice, he is recognized as one of the greatest Baroque composers, and his influence during his lifetime was widespread across Europe. He composed many instrumental concertos, for the violin and a variety of other instruments, as well as sacred choral works and more than forty operas.

Based on performing contextual unit segmentation 306, three contextual units 308-1, 308-2, 308-3 (collectively referred to herein as “contextual units 308” and individually referred to herein as “contextual unit 308”) may be generated. More specifically, a 1-gram approach may be used during contextual unit segmentation 306 to partition raw information item 304 into three contextual units 308. For example, each contextual unit 308 may include one sentence from raw information item 304. Contextual unit 308-1 may include the sentence “Antonio Lucio Vivaldi was an Italian Baroque composer, virtuoso violinist, teacher and cleric.” Contextual unit 308-2 may include the sentence “Born in Venice, he is recognized as one of the greatest Baroque composers, and his influence during his lifetime was widespread across Europe.” Contextual unit 308-3 may include the sentence “He composed many instrumental concertos, for the violin and a variety of other instruments, as well as sacred choral works and more than forty operas.”

In FIG. 3B, contextual units 308 may be used to perform synthetic data generation 310. For example, a first language model may be provided, as input, a prompt to trigger the first language model to generate synthetic data 312 based on contextual units 308. In this example, synthetic data generation 310 may include generating a first type/format of synthetic data 312 from 1-gram contextual units 308 and a second type/format of synthetic data 312, also from 1-gram contextual units 308. The first type/format of synthetic data 312 may include three question-context tuples. For example, each question-context pair may be generated based on one of the contextual units 308 shown in FIG. 3A. The second type/format of synthetic data 312 may include three question-context-answer tuples. For example, each question-context-answer pair may be generated based on one of the contextual units 308 shown in FIG. 3A.

Fine-tuning 316 may be performed on a second language model based on the generated question-context tuples. Fine-tuning 316 may also be performed on a third language model based on the generated question-context-answer tuples. The second language model and the third language model may comprise different language models, but may be a same type of language model, such as a same type of LLM. Further, a same technique for fine-tuning (e.g., SFT, CPT, etc.) may be used to fine tune the second language model and the third language model during fine-tuning 316.

Score generation 320 may be performed to evaluate the performance of each of the fine-tuned second language model and the fine-tuned third language model. More specifically, score generation 320 may include determining a first score associated with a performance of the fine-tuned second language model and determining a second score associated with a performance of the fine-tuned third language model. The first score and/or the second score may comprise an F1-score (also commonly referred to as an “F1-measure”). The F1-score is a metric that measures the performance of an algorithm. For example, the F1-score is a metric that that combines precision and recall to measure a model's accuracy. It's calculated using the harmonic mean of the two metrics, which balances their importance and encourages similar values. The F1-score ranges from 0 to 1, with 1 indicating perfect precision and recall.

The first score may be compared with the second score to determine which synthetic data generation strategy is the most effective for formatting raw information item 304 for knowledge injection, e.g., via fine-tuning, by the language model type associated with the second language model and the third language model.

FIGS. 4A and 4B depict another example fine-tuning performance evaluation 400 for different example knowledge refinement techniques. More specifically, fine-tuning performance evaluation 400 depicted in FIGS. 4A and 4B may be used to evaluate the knowledge injection performance of a language model based on synthetic data 312 generated based on contextual units 422, 424, and 426 created for a raw information item 304 using different n-gram approaches. For example, knowledge injection performance may be evaluated for (1) question-context tuples generated based on 1-gram first contextual units 422, (2) question-context tuples generated based on 2-gram second contextual units 424, and (3) a question-context pair generated on a 3-gram third contextual unit 426.

As shown in FIG. 4A, example raw information item 404 is a paragraph, comprising three sentences, which recites:
Antonio Lucio Vivaldi was an Italian Baroque composer, virtuoso violinist, teacher and cleric. Born in Venice, he is recognized as one of the greatest Baroque composers, and his influence during his lifetime was widespread across Europe. He composed many instrumental concertos, for the violin and a variety of other instruments, as well as sacred choral works and more than forty operas.

Contextual unit segmentation 406 may be performed three times for raw information item 404, such as to generate first contextual units 422, second contextual units 424, and a third contextual unit 426. More specifically, a 1-gram approach may be used during contextual unit segmentation 406 to partition raw information item 404 into three first contextual units 422. For example, each first contextual unit 422 may include one sentence from raw information item 404. First contextual unit 422-1 may include the sentence “Antonio Lucio Vivaldi was an Italian Baroque composer, virtuoso violinist, teacher and cleric.” First contextual unit 422-2 may include the sentence “Born in Venice, he is recognized as one of the greatest Baroque composers, and his influence during his lifetime was widespread across Europe.” First contextual unit 422-3 may include the sentence “He composed many instrumental concertos, for the violin and a variety of other instruments, as well as sacred choral works and more than forty operas.”

Further, a 2-gram approach may be used during contextual unit segmentation 406 to partition raw information item 404 into two second contextual units 424. For example, each second contextual unit 424 may include two sentences from raw information item 404. Second contextual unit 424-1 may include the sentences “Antonio Lucio Vivaldi was an Italian Baroque composer, virtuoso violinist, teacher and cleric. Born in Venice, he is recognized as one of the greatest Baroque composers, and his influence during his lifetime was widespread across Europe.” Second contextual unit 422-2 may include the sentences “Born in Venice, he is recognized as one of the greatest Baroque composers, and his influence during his lifetime was widespread across Europe. He composed many instrumental concertos, for the violin and a variety of other instruments, as well as sacred choral works and more than forty operas.”

Further, a 3-gram approach may be used during contextual unit segmentation 406 to partition raw information item 404 into one third contextual unit 426, more specifically third contextual unit 426-1. For example, third contextual unit 426-1 may include three sentences from raw information item 404. Third contextual unit 426-1 may include the sentences “Antonio Lucio Vivaldi was an Italian Baroque composer, virtuoso violinist, teacher and cleric. Born in Venice, he is recognized as one of the greatest Baroque composers, and his influence during his lifetime was widespread across Europe. He composed many instrumental concertos, for the violin and a variety of other instruments, as well as sacred choral works and more than forty operas.”

In FIG. 4B, contextual units 422, 424, and 426 may be used to perform synthetic data generation 410. For example, a first language model may be provided, as input, a prompt to trigger the first language model to generate synthetic data 412 based on contextual units 308. In this example, synthetic data generation 410 may include generating first question-context tuples from 1-gram first contextual units 422, second question-context tuples from 2-gram second contextual units 424, and a third question-context pair from 3-gram third contextual unit 426.

Fine-tuning 416 may be performed on a second language model based on the generated first question-context tuples. Fine-tuning 416 may also be performed on a third language model based on the generated second question-context pair. Further, fine-tuning 416 may be performed on a fourth language model based on the generated third question-context pair. The second language model, the third language model, and the fourth language model may comprise different language models, but may be a same type of language model, such as a same type of LLM. Further, a same technique for fine-tuning (e.g., SFT, CPT, etc.) may be used to fine tune the second language model and the third language model during fine-tuning 416.

Score generation 420 may be performed to evaluate the performance of each of the fine-tuned second language model, the fine-tuned third language model, and the fine-tuned fourth language model. More specifically, score generation 420 may include determining a first score associated with a performance of the fine-tuned second language model, determining a second score associated with a performance of the fine-tuned third language model, and determining a third score associated with a performance of the fine-tuned fourth language model.

The first score, second score, and third score may be compared to determine which synthetic data generation strategy (e.g., based on which n-gram approach) is the most effective for formatting raw information item 404 for knowledge injection, e.g., via fine-tuning, by the language model type associated with the second language model, the third language model, and the fourth language model.

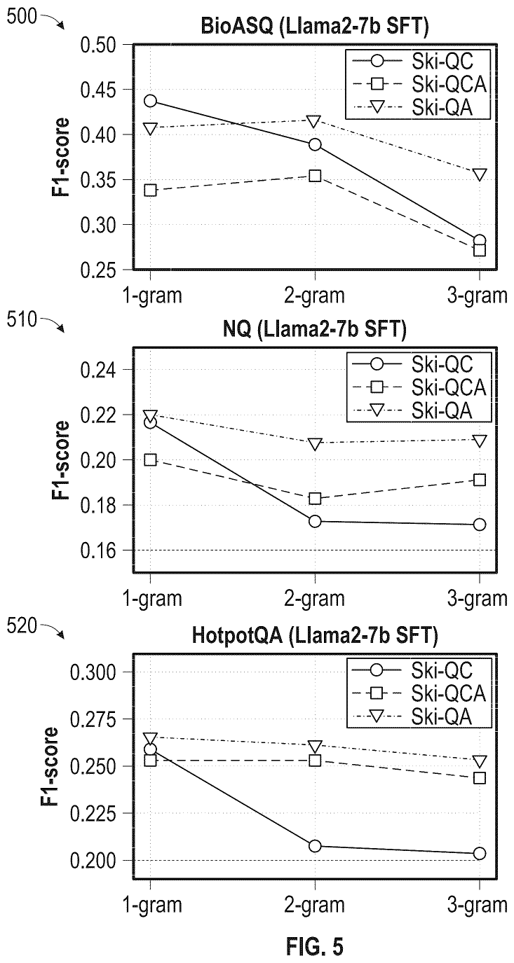

FIG. 5 depicts example SFT performance using different synthetic data generated for three different raw information items. As shown at 500, for a first raw information item, e.g., BioASQ, using question-context tuples, generated based on 1-gram contextual units associated with the first raw information item, may achieve the highest performance when fine-tuning a Llama2-7b model (e.g., an example language model). For example, a highest F1-score may be associated with question-context tuples generated based on the 1-gram contextual units.

As shown at 510 for a second raw information item, e.g., NQ, using question-context tuples and/or question-answer tuples, generated based on 1-gram contextual units associated with the second raw information item, may achieve the highest performance when fine-tuning a Llama2-7b model. For example, a highest F1-score may be associated with question-context tuples and question-answer tuples generated based on the 1-gram contextual units.

Additionally, as shown at 520 for a third raw information item, e.g., HotpotQA, using question-answer tuples, generated based on 1-gram contextual units associated with the third raw information item may achieve the highest performance when fine-tuning a Llama2-7b model. For example, a highest F1-score may be associated with question-answer tuples generated based on the 1-gram contextual units.

Thus, as shown in FIG. 5, different synthetic data generation techniques facilitate different levels of effective knowledge injection into an LLM, thereby resulting in different levels of performance of the LLM. Determining a “best” synthetic data generation technique, based on a model type, a raw information item, and/or an injection technique, and using this technique may directly improve performance of the LLM, such as with respect to a specific task and/or domain.

### Example Method for Language Model Fine-Tuning

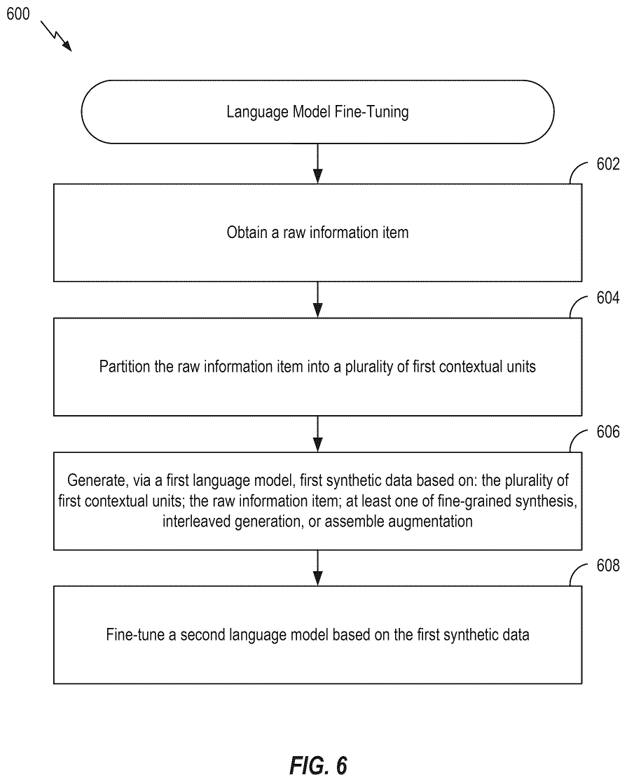

FIG. 6 depicts an example method 600 for language model fine-tuning, such as for fine-tuning an LLM. In one embodiment, method 600 can be implemented by the system 100 of FIG. 1 and/or processing system 500 of FIG. 5.

Method 600 starts at block 602 with obtaining a raw information item.

Method 600 continues to block 604 with partitioning the raw information item into a plurality of first contextual units. Each first contextual unit may include a first portion of the raw information item.

Method 600 continues to block 606 with generating, via a first language model, first synthetic data based on: the plurality of first contextual units; the raw information item; and at least one of fine-grained synthesis, interleaved generation, or assembly augmentation.

Method 600 continues to block 608 with fine-tuning a second language model based on the first synthetic data.

In certain embodiments, at block 606, generating the first synthetic data based on the fine-grained synthesis comprises generating at least one of: a plurality of questions, wherein each question is generated based on a respective first contextual unit of the plurality of first contextual units; or a plurality of question-context tuples, wherein: each question-context pair is generated based on a respective first contextual unit of the plurality of first contextual units, and each question-context pair comprises a question and the respective first contextual unit.

In certain embodiments, at block 606, generating the first synthetic data based on the interleaved generation comprises generating at least one of: a plurality of question-answer tuples, wherein: each question-answer pair is generated based on a respective first contextual unit of the plurality of first contextual units, and each question-answer pair comprise a respective question and a respective answer to the respective question; or a plurality of question-context-answer tuples, wherein: each question-context-answer tuple is generated based on a respective first contextual unit of the plurality of first contextual units, and each question-context-answer tuple comprises a respective question, a respective answer to the respective question, and the respective first contextual unit.

In certain embodiments, at block 606, generating the first synthetic data based on the assembly augmentation comprises generating at least one of: a combined question-answer set comprising a plurality of question-answer tuples; a combined question-context set comprising a plurality of question-context tuples; or a combined question-context-answer set comprising a plurality of question-context-answer tuples.

In certain embodiments, at block 604, partitioning the raw information item into the plurality of first contextual units comprises applying an n-gram based contextual unit segmentation procedure to the raw information item, and each first contextual unit of the plurality of first contextual units comprises a respective sequence of n consecutive sentences or words from the raw information item.

In certain embodiments, at block 608, fine-tuning the second language model is based on a supervised fine-tuning technique.

In certain embodiments, at block 610, fine-tuning the second language model is based on a continual pre-training technique.

In certain embodiments, method 600 further includes determining a first score associated with a performance of the second language model.

In certain embodiments, method 600 further includes: generating, via the first language model, second synthetic data based on: the plurality of first contextual units; the raw information item; and at least one of the fine-grained synthesis, the interleaved generation, or the assembly augmentation; fine-tuning a third language model based on the second synthetic data, wherein: the second language model and the third language model comprise a same model, and the first synthetic data and the second synthetic data are different; determining a second score associated with a performance of the third language model; and determining to use the second language model or the third language model based on the first score and the second score.

In certain embodiments, the raw information item is associated with a first domain. In certain embodiments, method 600 further includes prompting the fine-tuned second language model or the fine-tuned third language model to generate a response to a prompt associated with the first domain.

In certain embodiments, method 600 further includes partitioning the raw information item into a plurality of second contextual units, wherein each second contextual unit comprises a second portion of the raw information item; generating, via the first language model, second synthetic data based on: the plurality of first contextual units; the raw information item; and at least one of the fine-grained synthesis, the interleaved generation, or the assembly augmentation; fine-tuning a third language model based on the second synthetic data, wherein the second language model and the third language model comprise a same model; determining a second score associated with a performance of the third language model; and determining to use the second language model or the third language model based on the first score and the second score.

In certain embodiments, the raw information item comprises unstructured data.

In certain embodiments, the second language model comprises a large language model (LLM).

By leveraging at least one of fine-grained synthesis, interleaved generation, or repetition with assemblies, significant technical advantages over conventional solutions may be achieved. For example, such technique(s), when utilized, may offer a solution for generating synthetic data from raw knowledge, which is diverse, representative, and relevant, among other qualities. For example, the synthetic data generation technique(s) may beneficially help to generate synthetic data that is not too broad, which struggles to encompass all pertinent knowledge points of a raw information item, yet also not excessively detailed, which risks risk losing sight of the overall content provided by the raw information item. Moreover, the synthetic data generation technique(s) help to generate synthetic data that is both non-repetitive and diverse. As such, the synthetic data generation method described herein beneficially enhances the refinement of knowledge from its raw state, thereby facilitating effective knowledge injection into LLMs. For example, the generated synthetic data may be injected into an LLM, using one or more techniques, such as via fine-tuning. Accordingly, new information from external datasets may be incorporated into a pre-trained LLM and/or the LLM's capabilities on previously-seen information may be refined, thereby enhancing the performance of the LLM.

Note that FIG. 6 is just one example of a method, and other methods including fewer, additional, or alternative operations are possible consistent with this disclosure.

### Example Processing System for Knowledge Refinement and Language Model Fine-Tuning

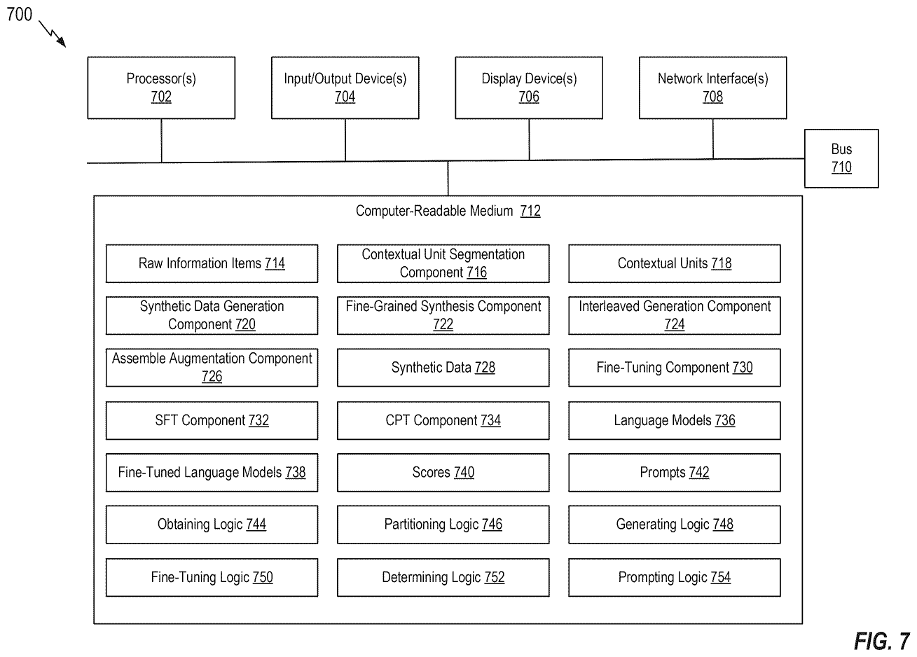

FIG. 7 depicts an example processing system 700 configured to perform various aspects described herein, including, for example, method 600 as described above with respect to FIG. 6.

Processing system 700 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 700 includes one or more processors 702, one or more input/output devices 704, one or more display devices 706, one or more network interfaces 708 through which processing system 700 is connected to one or more networks (e.g., a local network, an intranet, the Internet, or any other group of processing systems communicatively connected to each other), and computer-readable medium 712. In the depicted example, the aforementioned components are coupled by a bus 710, which may generally be configured for data exchange amongst the components. Bus 710 may be representative of multiple buses, while only one is depicted for simplicity.

Processor(s) 702 are generally configured to retrieve and execute instructions stored in one or more memories, including local memories like computer-readable medium 712, as well as remote memories and data stores. Similarly, processor(s) 702 are configured to store application data residing in local memories like the computer-readable medium 712, as well as remote memories and data stores. More generally, bus 710 is configured to transmit programming instructions and application data among the processor(s) 702, display device(s) 706, network interface(s) 708, and/or computer-readable medium 712. In certain embodiments, processor(s) 702 are representative of a one or more central processing units (CPUs), graphics processing unit (GPUs), tensor processing unit (TPUs), accelerators, and other processing devices.

Input/output device(s) 704 may include any device, mechanism, system, interactive display, and/or various other hardware and software components for communicating information between processing system 700 and a user of processing system 700. For example, input/output device(s) 704 may include input hardware, such as a keyboard, touch screen, button, microphone, speaker, and/or other device for receiving inputs from the user and sending outputs to the user.

Display device(s) 706 may generally include any sort of device configured to display data, information, graphics, user interface elements, and the like to a user. For example, display device(s) 706 may include internal and external displays such as an internal display of a tablet computer or an external display for a server computer or a projector. Display device(s) 706 may further include displays for devices, such as augmented, virtual, and/or extended reality devices. In various embodiments, display device(s) 706 may be configured to display a graphical user interface.

Network interface(s) 708 provide processing system 700 with access to external networks and thereby to external processing systems. Network interface(s) 708 can generally be any hardware and/or software capable of transmitting and/or receiving data via a wired or wireless network connection. Accordingly, network interface(s) 708 can include a communication transceiver for sending and/or receiving any wired and/or wireless communication.

Computer-readable medium 712 may be a volatile memory, such as a random access memory (RAM), or a nonvolatile memory, such as nonvolatile random access memory (NVRAM), or the like. In this example, computer-readable medium 712 includes raw information items 714, contextual unit segmentation component 716, contextual units 718, synthetic data generation component 720, fine-grained synthesis component 722, interleaved generation component 724, assembly augmentation component 726, synthetic data 728, fine-tuning component 730, SFT component 732, CPT component 734, language models 736, fine-tuned language models 738, scores 740, prompts 742, obtaining logic 744, partitioning logic 746, generating logic 748, fine-tuning logic 750, determining logic 752, and prompting logic 754.

In certain embodiments, obtaining logic 744 includes logic for obtaining a raw information item.

In certain embodiments, partitioning logic 746 includes logic for partitioning the raw information item into a plurality of first contextual units, wherein each first contextual unit comprises a first portion of the raw information item. In certain embodiments, partitioning logic 746 includes logic for partitioning the raw information item into the plurality of first contextual units comprises applying an n-gram based contextual unit segmentation procedure to the raw information item. In certain embodiments, partitioning logic 746 includes logic for partitioning the raw information item into a plurality of second contextual units, wherein each second contextual unit comprises a second portion of the raw information item.

In certain embodiments, generating logic 748 includes logic for generating, via a first language model, first synthetic data. In certain embodiments, generating logic 748 includes logic for generating a plurality of questions. In certain embodiments, generating logic 748 includes logic for generating a plurality of question-context tuples. In certain embodiments, generating logic 748 includes logic for generating a plurality of question-answer tuples. In certain embodiments, generating logic 748 includes logic for generating a plurality of question-context-answer tuples. In certain embodiments, generating logic 748 includes logic for generating a combined question-answer set comprising a plurality of question-answer tuples. In certain embodiments, generating logic 748 includes logic for generating a combined question-context set comprising a plurality of question-context tuples. In certain embodiments, generating logic 748 includes logic for generating a combined question-context-answer set comprising a plurality of question-context-answer tuples. In certain embodiments, generating logic 748 includes logic for generating, via the first language model, second synthetic data.

In certain embodiments, fine-tuning logic 750 includes logic for fine-tuning a second language model based on the first synthetic data. In certain embodiments, fine-tuning logic 750 includes logic for fine-tuning a third language model based on the second synthetic data. In certain embodiments, fine-tuning logic 750 includes logic for fine-tuning a third language model based on the second synthetic data, wherein the second language model and the third language model comprise a same model.

In certain embodiments, determining logic 752 includes logic for determining a first score associated with a performance of the second language model. In certain embodiments, determining logic 752 includes logic for determining a second score associated with a performance of the third language model. In certain embodiments, determining logic 752 includes logic for determining to use the second language model or the third language model based on the first score and the second score. In certain embodiments, determining logic 752 includes logic for determining a second score associated with a performance of the third language model. In certain embodiments, determining logic 752 includes logic for determining to use the second language model or the third language model based on the first score and the second score.

In certain embodiments, prompting logic 754 includes logic for prompting the fine-tuned second language model or the fine-tuned third language model to generate a response to a prompt associated with the first domain.

Note that FIG. 7 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A method of language model fine-tuning, comprising: obtaining a raw information item; partitioning the raw information item into a plurality of first contextual units, wherein each first contextual unit comprises a first portion of the raw information item; generating, via a first language model, first synthetic data based on: the plurality of first contextual units; the raw information item; and at least one of fine-grained synthesis, interleaved generation, or assembly augmentation; and fine-tuning a second language model based on the first synthetic data.

Clause 2: The method of Clause 1, wherein generating the first synthetic data based on the fine-grained synthesis comprises generating at least one of: a plurality of questions, wherein each question is generated based on a respective first contextual unit of the plurality of first contextual units; or a plurality of question-context tuples, wherein: each question-context pair is generated based on a respective first contextual unit of the plurality of first contextual units, and each question-context pair comprises a question and the respective first contextual unit.

Clause 3: The method of any one of Clauses 1-2, wherein generating the first synthetic data based on the interleaved generation comprises generating at least one of: a plurality of question-answer tuples, wherein: each question-answer pair is generated based on a respective first contextual unit of the plurality of first contextual units, and each question-answer pair comprise a respective question and a respective answer to the respective question; or a plurality of question-context-answer tuples, wherein: each question-context-answer tuple is generated based on a respective first contextual unit of the plurality of first contextual units, and each question-context-answer tuple comprises a respective question, a respective answer to the respective question, and the respective first contextual unit.

Clause 4: The method of any one of Clauses 1-3, wherein generating the first synthetic data based on the assembly augmentation comprises generating at least one of: a combined question-answer set comprising a plurality of question-answer tuples; a combined question-context set comprising a plurality of question-context tuples; or a combined question-context-answer set comprising a plurality of question-context-answer tuples.

Clause 5: The method of any one of Clauses 1-4, wherein: partitioning the raw information item into the plurality of first contextual units comprises applying an n-gram based contextual unit segmentation procedure to the raw information item, and each first contextual unit of the plurality of first contextual units comprises a respective sequence of n consecutive sentences or words from the raw information item.

Clause 6: The method of any one of Clauses 1-5, wherein fine-tuning the second language model is based on a supervised fine-tuning technique.

Clause 7: The method of any one of Clauses 1-6, wherein fine-tuning the second language model is based on a continual pre-training technique.

Clause 8: The method of any one of Clauses 1-7, further comprising determining a first score associated with a performance of the second language model.

Clause 9: The method of Clause 8, further comprising: generating, via the first language model, second synthetic data based on: the plurality of first contextual units; the raw information item; and at least one of the fine-grained synthesis, the interleaved generation, or the assembly augmentation; fine-tuning a third language model based on the second synthetic data, wherein: the second language model and the third language model comprise a same model, and the first synthetic data and the second synthetic data are different; determining a second score associated with a performance of the third language model; and determining to use the second language model or the third language model based on the first score and the second score.

Clause 10: The method of Clause 9, wherein: the raw information item is associated with a first domain, and the method further comprises prompting the fine-tuned second language model or the fine-tuned third language model to generate a response to a prompt associated with the first domain.

Clause 11: The method of any one of Clauses 8-10, further comprising: partitioning the raw information item into a plurality of second contextual units, wherein each second contextual unit comprises a second portion of the raw information item; generating, via the first language model, second synthetic data based on: the plurality of first contextual units; the raw information item; and at least one of the fine-grained synthesis, the interleaved generation, or the assembly augmentation; fine-tuning a third language model based on the second synthetic data, wherein the second language model and the third language model comprise a same model; determining a second score associated with a performance of the third language model; and determining to use the second language model or the third language model based on the first score and the second score.

Clause 12: The method of any one of Clauses 1-11, wherein the raw information item comprises unstructured data.

Clause 13: The method of any one of Clauses 1-12, wherein the second language model comprises a large language model (LLM).

Clause 14: A processing system, comprising: a memory comprising computer-executable instructions; and a processor configured to execute the computer-executable instructions and cause the processing system to perform a method in accordance with any one of Clauses 1-13.

Clause 15: A processing system, comprising means for performing a method in accordance with any one of Clauses 1-13.

Clause 16: A non-transitory computer-readable medium storing program code for causing a processing system to perform the steps of any one of Clauses 1-13.

Clause 17: A computer program product embodied on a computer-readable storage medium comprising code for performing a method in accordance with any one of Clauses 1-13.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of language model fine-tuning, comprising:
obtaining a raw information item;
partitioning the raw information item into a plurality of first contextual units, wherein each first contextual unit comprises a first portion of the raw information item;
generating, via a first language model, first synthetic data based on:
the plurality of first contextual units;
the raw information item; and
at least one of fine-grained synthesis, interleaved generation, or assembly augmentation; and
fine-tuning a second language model based on the first synthetic data.

2. The method of claim 1, wherein generating the first synthetic data based on the fine-grained synthesis comprises generating at least one of:
a plurality of questions, wherein each question is generated based on a respective first contextual unit of the plurality of first contextual units; or
a plurality of question-context tuples, wherein:
each question-context pair is generated based on a respective first contextual unit of the plurality of first contextual units, and
each question-context pair comprises a question and the respective first contextual unit.

3. The method of claim 1, wherein generating the first synthetic data based on the interleaved generation comprises generating at least one of:
a plurality of question-answer tuples, wherein:
each question-answer pair is generated based on a respective first contextual unit of the plurality of first contextual units, and
each question-answer pair comprise a respective question and a respective answer to the respective question; or
a plurality of question-context-answer tuples, wherein:
each question-context-answer tuple is generated based on a respective first contextual unit of the plurality of first contextual units, and
each question-context-answer tuple comprises a respective question, a respective answer to the respective question, and the respective first contextual unit.

4. The method of claim 1, wherein generating the first synthetic data based on the assembly augmentation comprises generating at least one of:
a combined question-answer set comprising a plurality of question-answer tuples;
a combined question-context set comprising a plurality of question-context tuples; or
a combined question-context-answer set comprising a plurality of question-context-answer tuples.

5. The method of claim 1, wherein:
partitioning the raw information item into the plurality of first contextual units comprises applying an n-gram based contextual unit segmentation procedure to the raw information item, and
each first contextual unit of the plurality of first contextual units comprises a respective sequence of n consecutive sentences or words from the raw information item.

6. The method of claim 1, wherein fine-tuning the second language model is based on a supervised fine-tuning technique.

7. The method of claim 1, wherein fine-tuning the second language model is based on a continual pre-training technique.

8. The method of claim 1, further comprising determining a first score associated with a performance of the second language model.

9. The method of claim 8, further comprising:
generating, via the first language model, second synthetic data based on:
the plurality of first contextual units;
the raw information item; and
at least one of the fine-grained synthesis, the interleaved generation, or the assembly augmentation;
fine-tuning a third language model based on the second synthetic data, wherein:
the second language model and the third language model comprise a same model, and
the first synthetic data and the second synthetic data are different;
determining a second score associated with a performance of the third language model; and
determining to use the second language model or the third language model based on the first score and the second score.

10. The method of claim 9, wherein:
the raw information item is associated with a first domain, and
the method further comprises prompting the fine-tuned second language model or the fine-tuned third language model to generate a response to a prompt associated with the first domain.

11. The method of claim 8, further comprising:
partitioning the raw information item into a plurality of second contextual units, wherein each second contextual unit comprises a second portion of the raw information item;
generating, via the first language model, second synthetic data based on:
the plurality of first contextual units;
the raw information item;
at least one of the fine-grained synthesis, the interleaved generation, or the assembly augmentation;
fine-tuning a third language model based on the second synthetic data, wherein the second language model and the third language model comprise a same model;
determining a second score associated with a performance of the third language model; and
determining to use the second language model or the third language model based on the first score and the second score.

12. The method of claim 1, wherein the second language model comprises a large language model (LLM).

13. A processing system, comprising: a memory comprising computer-executable instructions; and a processor configured to execute the computer-executable instructions and cause the processing system to:
obtain a raw information item;
partition the raw information item into a plurality of first contextual units, wherein each first contextual unit comprises a first portion of the raw information item;
generate, via a first language model, first synthetic data based on:
the plurality of first contextual units;
the raw information item; and
at least one of fine-grained synthesis, interleaved generation, or assembly augmentation; and
fine-tune a second language model based on the first synthetic data.

14. The processing system of claim 13, wherein to generate the first synthetic data based on the fine-grained synthesis, the processor is configured to execute the computer-executable instructions and cause the processing system to generate at least one of:
a plurality of questions, wherein each question is generated based on a respective first contextual unit of the plurality of first contextual units; or
a plurality of question-context tuples, wherein:
each question-context pair is generated based on a respective first contextual unit of the plurality of first contextual units, and
each question-context pair comprises a question and the respective first contextual unit.

15. The processing system of claim 13, wherein to generate the first synthetic data based on the interleaved generation, the processor is configured to execute the computer-executable instructions and cause the processing system to generate at least one of:
a plurality of question-answer tuples, wherein:
each question-answer pair is generated based on a respective first contextual unit of the plurality of first contextual units, and
each question-answer pair comprise a respective question and a respective answer to the respective question; or
a plurality of question-context-answer tuples, wherein:
each question-context-answer tuple is generated based on a respective first contextual unit of the plurality of first contextual units, and
each question-context-answer tuple comprises a respective question, a respective answer to the respective question, and the respective first contextual unit.

16. The processing system of claim 13, wherein to generate the first synthetic data based on the assembly augmentation, the processor is configured to execute the computer-executable instructions and cause the processing system to generate at least one of:
a combined question-answer set comprising a plurality of question-answer tuples;
a combined question-context set comprising a plurality of question-context tuples; or
a combined question-context-answer set comprising a plurality of question-context-answer tuples.

17. The processing system of claim 13, wherein:
to partition the raw information item into the plurality of first contextual units, the processor is configured to execute the computer-executable instructions and cause the processing system to apply an n-gram based contextual unit segmentation procedure to the raw information item, and
each first contextual unit of the plurality of first contextual units comprises a respective sequence of n consecutive sentences or words from the raw information item.

18. The processing system of claim 13, wherein to fine-tune the second language model, the processor is configured to execute the computer-executable instructions and cause the processing system to fine-tune the second language model based on a supervised fine-tuning technique.

19. The processing system of claim 13, wherein to fine-tune the second language model, the processor is configured to execute the computer-executable instructions and cause the processing system to fine-tune the second language model based on a continual pre-training technique.

20. The processing system of claim 13, wherein the processor is configured to execute the computer-executable instructions and cause the processing system to determine a first score associated with a performance of the second language model.
